(19) United States
(12) Patent Application Publication
(10) Pub. No.: US 2025/0370710 A1
(43) Pub. Date: Dec. 4, 2025

(54) APPARATUS FOR OPERATING DEEP NEURAL NETWORK FOR ENERGY-EFFICIENT FLOATING-POINT OPERATION AND METHOD FOR FLOATING-POINT OPERATION USING THE SAME

(71) Applicant: Korea Advanced Institute of Science and Technology, Daejeon (KR)

(72) Inventors: Hoi Jun YOO, Daejeon (KR); Won hoon PARK, Daejeon (KR)

(73) Assignee: Korea Advanced Institute of Science and Technology, Daejeon (KR)

(21) Appl. No.: 19/023,539

(22) Filed: Jan. 16, 2025

(30) Foreign Application Priority Data
May 31, 2024 (KR) 10-2024-0071934

(51) Int. Cl. G06F 7/499; G06F 7/483

(52) U.S. Cl. CPC G06F 7/49915; G06F 7/483

(57) ABSTRACT

An apparatus for a DNN operation includes a preprocessor configured to classify outlier data and inlier data from a predetermined number of pieces of grouped and input floating-point data and to perform presorting on the inlier data, a CIM operator configured to perform a fixed-point operation on the inlier data, an NPU operator configured to receive the outlier data and corresponding input channel information from the preprocessor and to perform a floating-point operation on the outlier data, and an aggregation core configured to sum and output an operation result of each of the CIM operator and the NPU operator, wherein the NPU operator reads a weight for each input channel for the floating-point operation on the outlier data through a separate transmission line implemented in the CIM operator, and causes the outlier data to be processed in parallel with an operation cycle of the inlier data.

### CROSS-REFERENCE TO RELATED APPLICATION

This application claims the benefit of priority under 35 U.S.C. § 119(a) to Korean Patent Application No. 10-2024-0071934, filed on May 31, 2024, the entire contents of which are incorporated herein by reference.

### BACKGROUND OF THE INVENTION

### Field of the Invention

The present invention relates to an apparatus for operating a deep neural network (DNN) and an operating method using the same, and more particularly to an apparatus for operating a DNN for an energy-efficient floating-point operation and a method for a floating-point operation using the same.

### Description of the Related Art

A DNN used in artificial intelligence (AI) applications exhibits excellent performance in various fields such as image recognition, speech and recognition, natural language processing. However, as the application fields of AI become more advanced, the burden of the DNN operation is increasing, and accordingly, there is demand for a processor/operator that operates the DNN with high performance and energy efficiency.

In this regard, Y.-D. Chih et al., “16.4 An 89TOPS/W and 16.3TOPS/mm2 AllDigital SRAM-Based Full-Precision Compute-In Memory Macro in 22 nm for Machine-Learning Edge Applications,” 2021 IEEE International Solid-State Circuits Conference (ISSCC), 2021, pp. 252-254 discloses a computing-in-memory (CIM) technology. The CIM technology directly processes a large number of parallel multiply-accumulate (MAC) operations in a memory to enable data processing only by single memory access, thereby achieving high energy efficiency. However, most CIM processors only support fixed-point operations, which limits the ability to support floating-point (FP) representations having a wide dynamic range required by various applications.

For this reason, J. Lee et al., “A 13.7 TFLOPS/W Floating- point DNN Processor using Heterogeneous Operating Architecture with ExponentOperating-in-Memory,” 2021 Symposium on VLSI Circuits, 2021, pp. 1-2 discloses a technology for separating an exponent and a mantissa and processing only an operation of the exponent in a CIM as a CIM processor that supports a floating-point operation. However, in this case, since only operation for a single cycle is supported, there is a problem of low throughput.

Meanwhile, F. Tu et al., “A 28 nm 29.2TFLOPS/W BF16 and 36.5TOPS/W INT8 Reconfigurable Digital CIM Processor with Unified FP/INT Pipeline and Bitwise In-Memory Booth Multiplication for Cloud Deep Learning Acceleration,” 2022 IEEE International Solid-State Circuits Conference (ISSCC), 2022, pp. 1-3 discloses a fixed-point CIM structure that performs pre-alignment to align mantissas according to a difference in exponents in order to achieve high energy efficiency. However, since some data is lost near the least significant bit (LSB) after the pre-alignment, there is a problem of accuracy loss.

### SUMMARY OF THE INVENTION

Therefore, the present invention has been made in view of the above problems, and provides an apparatus for operating a DNN for an energy-efficient floating-point operation and a method for a floating-point operation using the same capable of improving operation speed and energy efficiency by classifying a predetermined number of pieces of floating-point data grouped and input for an operation into outlier data and inlier data, separating and processing these pieces of data through a separate operator, and then summing and outputting respective operation results.

In addition, the present invention provides an apparatus for operating a DNN for an energy-efficient floating-point operation which includes a CIM operator configured to perform a fixed-point operation on inlier data and a neural processing unit (NPU) configured to perform a floating-point operation on outlier data, and provides a weight required for the floating-point operation using a transmission path separate from a data path for the fixed-point operation of the CIM operator, thereby enabling parallel processing of the outlier data and the inlier data, and a method for a floating-point operation using the same.

In addition, the present invention provides an apparatus for operating a DNN for an energy-efficient floating-point operation which caches a previously used weight for each input channel of outlier data, and then uses the cached weight during operation of the outlier data on the same channel, so that a process of loading a weight from a CIM operator may be omitted, thereby reducing a total read cycle to achieve higher throughput and energy efficiency, and a method for a floating- point operation using the same.

In accordance with an aspect of the present invention, the above and other objects can be accomplished by the provision of an apparatus for a deep neural network (DNN) operation including a preprocessor configured to classify outlier data and inlier data from a predetermined number of pieces of grouped and input floating-point data and to perform presorting on the inlier data, a computing-in-memory (CIM) operator configured to perform a fixed-point operation on the inlier data, an NPU operator configured to receive the outlier data and corresponding input channel information from the preprocessor and to perform a floating-point operation on the outlier data, and an aggregation core configured to sum and output an operation result of each of the CIM operator and the NPU operator, wherein the NPU operator reads a weight for each input channel for the floating-point operation on the outlier data through a separate transmission line implemented in the CIM operator, and causes the outlier data to be processed in parallel with an operation cycle of the inlier data.

Preferably, the preprocessor may include an outlier searcher configured to find a maximum exponent value Emax among exponent values of each piece of the floating-point data, and then determine floating-point data, in which a difference between an exponent value and the maximum exponent value Emax exceeds a preset threshold Th, as outlier data, and a mantissa preprocessor configured to presort mantissa values based on a difference value between the maximum exponent value Emax and the exponent value for each piece of remaining inlier data excluding the outlier data among the pieces of floating-point data.

Preferably, the outlier searcher may include a comparator configured to extract the maximum exponent value Emax by a comparison tree, a bias operator configured to calculate a difference value between the maximum exponent value Emax and an exponent value of each piece of the floating- point data, and a comparator configured to compare each difference value with the preset threshold Th to determine whether data is outlier data.

Preferably, the mantissa preprocessor may include a converter configured to convert a mantissa value of each piece of the inlier data to a 2's complement form including a corresponding sign, and a shift operator configured to perform a shift operation on the mantissa value based on the difference value.

Preferably, the CIM operator may include a plurality of CIM cells storing a 1-bit weight for the DNN operation, and each of the CIM cell may include an SRAM cell configured to support an operation of reading/writing the weight through a read word line RWL and a read bit line pair RBL/RBLB and to transfer the weight to the NPU operator, and a NOR operator configured to receive input of the inlier data through a compute work line CWL implemented separately from the read word line RWL and to perform a multiplication operation on the inlier data and the weight.

Preferably, the NPU operator may include at least one single instruction multiple data (SIMD) core matched with the CIM operator to perform the floating-point operation, and the SIMD core may include a plurality of SIMD lines configured to perform a floating-point operation on pieces of outlier data sequentially input from the preprocessor according to an input channel thereof, an outlier cache configured to store a weight for each input channel read from the CIM operator in a previous floating-point operation, and a cache controller configured to read a weight for each input channel of each piece of outlier data of a currently input floating-point data group from the outlier cache and to load the read weight into the SIMD line.

Preferably, the cache controller may further perform a process of requesting a weight from the CIM operator for an input channel whose corresponding weight is not stored in the outlier data among input channels of the outlier data and storing a received weight in the outlier cache in response thereto.

In accordance with another aspect of the present invention, there is provided a method for a floating-point operation using an apparatus for a DNN operation including a preprocessor configured to perform preprocessing on a predetermined number of pieces of grouped and input floating-point data for a floating-point operation, a CIM operator configured to perform a fixed-point operation on inlier data, an NPU operator configured to perform a floating-point operation on outlier data, and an aggregation core configured to sum and output an operation result of each of the CIM operator and the NPU operator, the method including a preprocessing step of classifying, by the preprocessor, outlier data and inlier data from a predetermined number of pieces of grouped and input floating-point data and performing presorting on the inlier data, a CIM operation step of performing, by the CIM operator, a fixed-point operation on the inlier data, an NPU operation step of receiving, by the NPU operator, the outlier data and corresponding input channel information from the preprocessor and performing a floating-point operation on the outlier data, and an aggregation step of summing and outputting, by the aggregation core, an operation result of each of the CIM operation step and the NPU operation step, wherein the NPU operation step includes reading a weight for each input channel for the floating-point operation on the outlier data through a separate transmission line implemented in the CIM operator, and causing the outlier data to be processed in parallel with an operation cycle of the inlier data.

Preferably, the preprocessing step may include an outlier search step of finding a maximum exponent value Emax among exponent values of each piece of the floating-point data, and then determining floating-point data, in which a difference between an exponent value and the maximum exponent value Emax exceeds a preset threshold Th, as outlier data, and a mantissa presorting step of presorting mantissa values based on a difference value between the maximum exponent value Emax and the exponent value for each piece of remaining inlier data excluding the outlier data among the pieces of floating-point data.

Preferably, the outlier search step may include a maximum exponent value Emax extraction step of extracting the maximum exponent value Emax by a comparison tree, a bias operation step of calculating a difference value between the maximum exponent value Emax and an exponent value of each piece of the floating-point data, and a comparison step of comparing each difference value with the preset threshold Th to determine whether data is outlier data.

Preferably, the mantissa presorting step may include a conversion step of converting a mantissa value of each piece of the inlier data to a 2's complement form including a corresponding sign, and a shift operation step of performing a shift operation on the mantissa value based on the difference value.

Preferably, the CIM operation step may include a weight storage step of storing a 1-bit weight for the DNN operation in a plurality of CIM cells for processing a CIM operation, a fixed-point operation step of receiving input of the inlier data by a signal of a compute work line CWL implemented separately from a read word line RWL of each of the CIM cell and performing a multiplication operation on the inlier data and the weight, and a weight transfer step of transferring the weight to the NPU operator by a read word line RWL and read bit line pair RBL/RBLB signal applied to the CIM cell.

Preferably, the NPU operation step may include floating-point operation step of performing a floating-point operation on the outlier data using a weight for each input channel read from the CIM operator, and a weight caching step of storing the weight used for the floating-point operation for each input channel in an outlier cache, and the floating-point operation step may include a weight loading step of loading a weight for each input channel prestored in the outlier cache for an operation of each piece of the outlier data.

Preferably, the NPU operation step may include a weight request step of requesting a weight from the CIM operator for an input channel whose corresponding weight is not stored in the outlier data among input channels of the outlier data, and a weight storage step of storing a weight received from the CIM operator in the outlier cache.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of a DNN operation apparatus according to an embodiment of the present invention;

FIG. 2 is a schematic block diagram of a preprocessor according to an embodiment of the present invention;

FIG. 3 is a schematic block diagram of a CIM operator according to an embodiment of the present invention;

FIG. 4 is a diagram illustrating a CIM cell structure including a separated data path according to an embodiment of the present invention;

FIG. 5 is a schematic block diagram of an NPU operator according to an embodiment of the present invention;

FIG. 6 is a schematic block diagram of an SIMD core according to an embodiment of the present invention;

FIGS. 7 to 12 are processing flowcharts of a method for a floating-point operation using the DNN operation apparatus according to an embodiment of the present invention; and

FIGS. 13 and 14 are diagrams illustrating and describing effects of the DNN operation apparatus and the method for the floating-point operation using the same according to an embodiment of the present invention.

### DETAILED DESCRIPTION OF THE INVENTION

Hereinafter, embodiments of the present invention will be described with reference to the attached drawings, and will be described in detail so that those skilled in the art may easily practice the present invention. However, the present invention may be implemented in many different forms and is not limited to the embodiments described herein. Meanwhile, to clearly describe the present invention in the drawings, parts unrelated to the description are omitted, and similar parts are given similar reference numerals throughout the specification. In addition, descriptions of parts, which may be easily understood by those skilled in the art even when detailed descriptions are omitted, are omitted.

Throughout the specification and claims, when a part is described as including a certain component, this means that other components may be further included rather than excluding other components, unless specifically stated to the contrary.

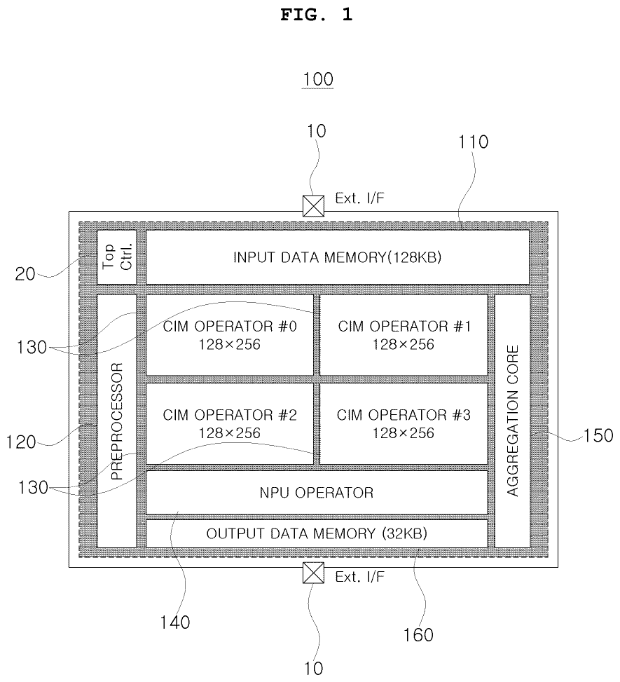

FIG. 1 is a schematic block diagram of a DNN operation apparatus according to an embodiment of the present invention. Referring to FIG. 1, the DNN operation apparatus 100 according to the embodiment of the present invention includes a plurality of gateways 10, a top controller 20, an input data memory 110, a preprocessor 120, a plurality of CIM operators 130, an NPU operator 140, an aggregation core 150, and an output data memory 160.

The gateways 10 may connect an external memory (not illustrated) and the DNN operation apparatus 100. The gateways 10 may be used to transfer weights stored in the external memory (not illustrated) to the DNN operation apparatus 100 and transfer processing results generated in the DNN operation apparatus 100 to the external memory (not illustrated).

The top controller 20 controls the overall operation of the DNN operation apparatus 100, particularly manages communication of each of components (that is, the input data memory 110, the preprocessor 120, the plurality of CIM operators 130, the NPU operator 140, the aggregation core 150, and the output data memory 160), and performs general processing required for DNN operation, such as batch normalization and activation function operation.

The input data memory 110 stores data input for DNN operation. In particular, the input data memory 110 may group and then store a series of pieces of data in a direction of a single pixel and input channel for input data of the DNN. That is, the input data memory 110 may group and store pieces of data in which the pixel direction and the input channel (i.ch) direction of input matrices input for DNN operation are the same.

The preprocessor 120 performs preprocessing on data grouped and input through the input data memory 110 according to components of a floating point (that is, a sign, an exponent, and a mantissa included in the floating point). That is, the preprocessor 120 classifies outlier data and inlier data from a predetermined number of pieces of grouped and input floating-point data, and performs presorting on the inlier data.

In this way, the preprocessed data is allocated to the CIM operator 130 or the NPU operator 140 and operated on according to data characteristics. That is, the inlier data is allocated to the CIM operator 130, and the outlier data is allocated to the NPU operator 140.

The CIM operator 130 performs a fixed-point operation on the inlier data transferred from the preprocessor 120. In particular, the CIM operator 130 performs a bit-serial operation on the input data through a CIM cell.

The NPU operator 140 performs a floating-point operation on the outlier data transferred from the preprocessor 120. In particular, the NPU operator 140 performs a bit-parallel operation on the input data through a digital MAC operator.

Meanwhile, the NPU operator 140 may receive input channel information of the outlier data from the preprocessor 120, and read a weight for each input channel for the floating-point operation on the outlier data from the CIM operator 130.

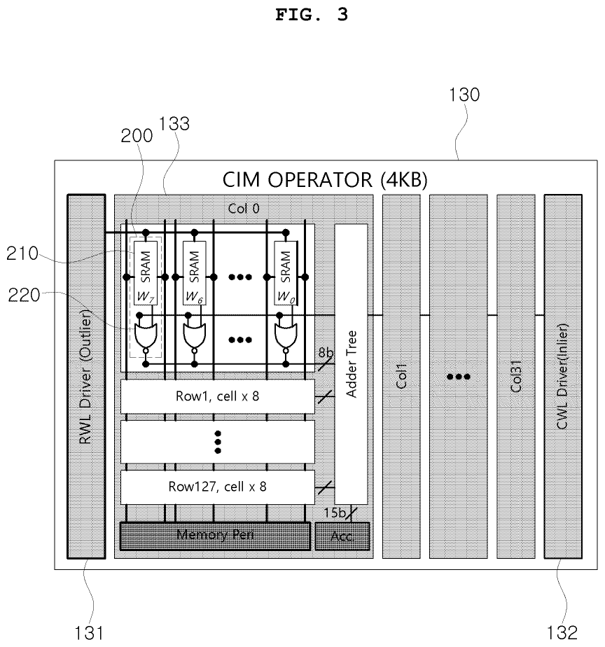

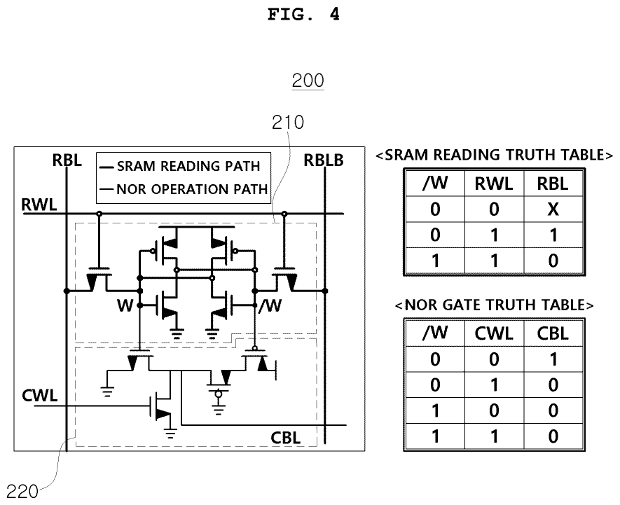

To this end, the NPU operator 140 is configured to be able to receive data from the CIM operator 130 through a data path connected to the CIM operator 130, and the CIM operator 130 may store a 1-bit weight for each of a plurality of CIM cells included in the CIM operator 130, and transmit the weight for each input channel to the NPU operator 140 using a separate weight transmission path separated from a data transmission path for fixed-point operation on the inlier data. A specific configuration and operation of the CIM operator 130 will be described later with reference to FIGS. 3 and 4.

Therefore, the NPU operator 140 may process the operation of the outlier data in parallel with an operation cycle of the inlier data. That is, normally, there is a characteristic in which, as a proportion of outliers increases, it becomes difficult to process the outlier operation within the operation cycle of the inlier data. However, the NPU operator 140 of the present invention receives a weight from the CIM operator 130 and caches the weight, thereby enabling the outlier operation to be processed within the operation cycle of the inlier data.

Meanwhile, one DNN operation apparatus 100 may include a greater number of CIM operators 130 than NPU operators 140 since a proportion of inlier data is higher than that of outlier data in a predetermined number of pieces of floating-point data that are grouped and input. FIG. 1 illustrates an example in which one DNN operation apparatus 100 includes four CIM operators 130 and one NPU operator 140.

The aggregation core 150 sums operation results of each of the plurality of CIM operators 130 and the NPU operator 140, and then stores a result thereof in the output data memory 160.

The output data memory 160 stores the operation results of the aggregation core 150.

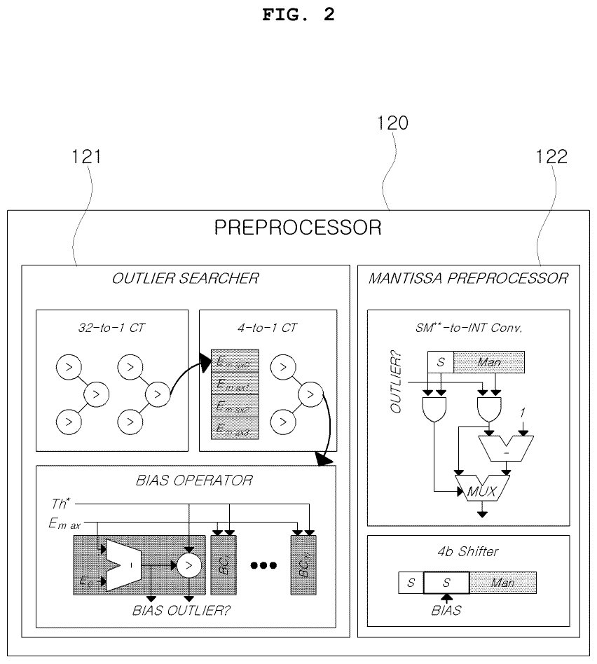

FIG. 2 is a schematic block diagram of the preprocessor according to an embodiment of the present invention. Referring to FIGS. 1 and 2, the preprocessor 120 includes an outlier searcher 121 and a mantissa preprocessor 122.

The outlier searcher 121 classifies outlier data and inlier data from a predetermined number of pieces of input floating-point data. That is, the outlier searcher 121 finds a maximum exponent value Emax whose value is the maximum among exponent values of each piece of the floating-point data input for the DNN operation, and then searches for outlier data based on a difference between the exponent value and the maximum exponent value Emax. For example, the outlier searcher 121 determines floating-point data, in which a difference between the exponent value and the maximum exponent value Emax exceeds a preset threshold Th, as outlier data. To this end, the outlier searcher 121 may include a comparator that extracts the maximum exponent value Emax by a comparison tree, a bias operator that calculates a difference value between the maximum exponent value Emax and an exponent value of each piece of the floating-point data, and a comparator that compares each difference value with the preset threshold Th (for example, 4) to determine whether the data is outlier data. In this instance, when an operation result of the bias operator exceeds the threshold, the comparator may classify the corresponding data as outlier data.

The mantissa preprocessor 122 performs a shift operation on a mantissa value based on an exponent difference obtained from the outlier searcher 121. In this instance, the mantissa value has been converted to a 2's complement form including the sign of each piece of data. That is, the mantissa preprocessor 122 presorts mantissa values based on the difference value between the maximum exponent value Emax and the exponent value for each piece of the remaining inlier data excluding the outlier data among the predetermined number of pieces of input floating-point data. To this end, the mantissa preprocessor 122 may include a converter that converts a mantissa value of each piece of the inlier data to a 2's complement form including the corresponding sign, and a shift operator that performs a shift operation on the mantissa value based on the difference value.

FIG. 3 is a schematic block diagram of the CIM operator according to an embodiment of the present invention, and FIG. 4 is a diagram illustrating a CIM cell structure including a separated data path according to an embodiment of the present invention.

Referring to FIGS. 1, 3, and 4, the CIM operator 130 according to an embodiment of the present invention includes 32 columns 133 and 128 rows, each column includes eight CIM cells 200, and the CIM cell 200 is based on an SRAM cell 210 including six transistors and includes a NOR operator 220 including four transistors.

In this instance, each CIM cell 200 stores weight data 1b of the DNN, and includes a separate data path that enables processing of outliers through connection of the CIM operator 130 and the NPU operator 140.

The SRAM cell 210 supports SRAM read/write operations through a connected read word line RWL and a read bit line pair RBL/RBLB. In this instance, the SRAM read operation is controlled by a read word line driver (RWL driver) 131, and may contribute to the floating-point operation of the outlier data by reading DNN weight data and transferring the DNN weight data to the NPU operator 140.

The NOR operator 220 receives input of the inlier data through a compute word line CWL implemented separately from the read word line RWL, and performs a multiplication operation on the inlier data and the weight. That is, an operation of the NOR operator 220 is controlled by a computing word line driver CWL driver 132, and the NOR operator 220 performs a fixed-point operation on the inlier data. An operation result of the NOR operator 220 is MAC-operated in an AdderTree connected to a rear end, and then transferred to the aggregation core 150.

The present invention enables the SRAM read operation and the NOR operation to be simultaneously performed using the structure of the CIM Cell 210 having the separated data path. In this way, the inlier and outlier operations are simultaneously performed, contributing to improvement in data processing speed and an increase in overall system energy efficiency.

In this instance, each of the columns 133 may store a weight in an output channel direction of the DNN, and each row may store a weight in an input channel direction.

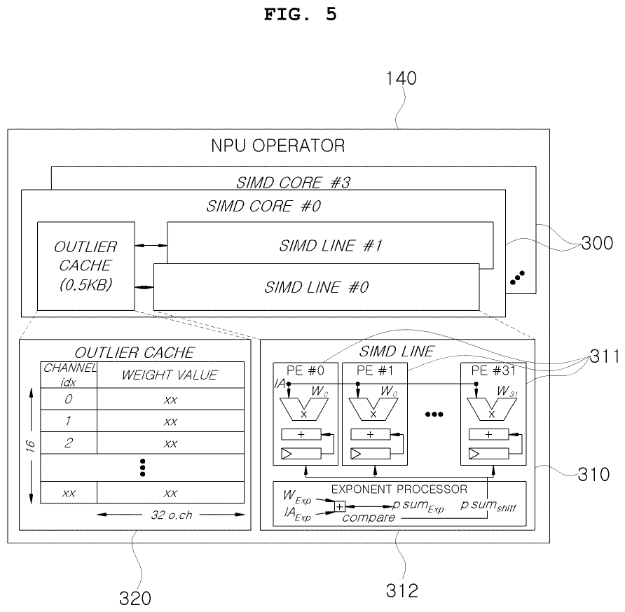

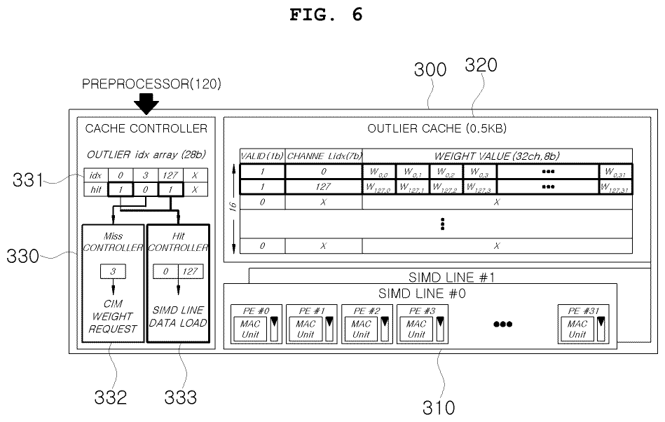

FIG. 5 is a schematic block diagram of the NPU operator according to an embodiment of the present invention, and FIG. 6 is a schematic block diagram of an SIMD core according to an embodiment of the present invention.

Referring to FIGS. 1, 5, and 6, the NPU operator 140 according to an embodiment of the present invention includes at least one single instruction multiple data (SIMD) core 300 matched with the CIM operator 130 to perform a floating-point operation. FIG. 5 illustrates an example in which one NPU operator 140 includes four SIMD cores 300.

Each SIMD core 300 includes two SIMD lines 310, an outlier cache 320, and a cache controller 330, and performs operations by being matched one-to-one or many-to-one with the CIM operator according to a model and layer structure of the DNN.

The SIMD line 310 performs a floating-point operation on pieces of outlier data sequentially input from the preprocessor 120 according to an input channel thereof.

To this end, the SIMD line 310 includes 32 processing elements (PEs) 311 and an exponent processor 312, and each of the PES 311 primarily performs a fixed-point operation, transfers a result to the exponent processor 312, receives a result of calculating an exponent difference between a currently accumulated partial sum psum and a multiplication result of a current operation for each operation from the exponent processor 312, and performs a floating-point operation.

The exponent processor 312 calculates the exponent difference between the currently accumulated partial sum psum and the multiplication result of the current operation for each operation and transfers a result to each PE 311.

Meanwhile, each SIMD line 310 performs a MAC operation for one channel per cycle, and the SIMD core 300 may minimize the stall of the operator through independent cache access. As a result, the SIMD core 300 of the present invention may have processing capacity up to twice that of the conventional technology.

The outlier cache 320 stores a weight for each input channel read from the CIM operator 130 in the previous floating-point operation. To this end, the outlier cache 320 has 16 rows indicating input channels of weight data, and each row may store weight data in a direction of 32 output channels, corresponding channel information (that is, 7-bit input channel index), and 1 valid bit indicating whether the corresponding weight is valid.

In addition, the outlier cache 320 is controlled by the cache controller 330 described below, and is shared by two SIMD lines 310, and transfers a weight value corresponding to a channel index ch idx required by each SIMD line 310.

The cache controller 330 manages a cache table 331 that indicates whether a weight corresponding to an input channel of floating-point data classified as outlier data for each input channel in a currently input floating-point data group is stored in the outlier cache 320. To this end, the cache controller 330 may receive an outlier search result (that is, input channel information of outlier data) (for example, outlier idx array) from the preprocessor 120, and then access the outlier cache 320 using a channel index in the outlier idx array to verify whether a weight for the corresponding channel is stored in the outlier cache 320.

In addition, the cache controller 330 verifies whether there is a cache for an input channel corresponding to the cache table 331, then performs a control operation to read a weight from the outlier cache 320 for a channel where a cache is present (that is, a Hit channel) and load the weight into the SIMD line 310, and performs a control operation to request a weight from the CIM operator 130 for a channel where a cache is not present (that is, a Miss channel) and store a weight received in response to the request in the outlier cache 320. To this end, the cache controller 330 may include a Miss controller 332 for controlling the Miss channel, and a Hit controller 333 for controlling the Hit channel.

In addition, the cache controller 330 may check a valid bit corresponding to a channel-specific weight present in the outlier cache 320 to determine whether the corresponding weight is valid, and when the corresponding weight is invalid, the cache controller 330 may perform a control operation to request weight data from the CIM operator 130 for the corresponding channel.

FIG. 6 illustrates an example in which an input channel idx of the outlier data derived from the outlier idx array received from the preprocessor 120 by the cache controller 330 is 0, 3, and 127, and weights whose input channels idx correspond to 0 and 127 among 0, 3, and 127 are registered in the outlier cache 320.

In this case, 1 is stored in a hit area of a cache table where the input channel idx is 0 and 127, 0 is stored in a hit area of a cache table where the input channel idx is 3, an index of a channel where a cache is not present, (that is, 3) is transmitted to the Miss controller 332, and an index of a channel where a cache is present (that is, 0 and 127) is transferred to the Hit controller 333.

The Miss controller 332 requests a weight from the CIM operator 130 using an index of a channel where a cache is not present in the outlier cache 320 (that is, 3), reads a weight value of the corresponding channel through an SRAM read operation of the CIM cell, stores the weight value in the outlier cache 320, and then transfers the channel index (that is, 3) to the Hit controller 333.

The hit controller 333 stores channel information in which a cache is present in the outlier cache 320 and uses the information to load the corresponding weight from the outlier cache 320 to the SIMD line 310. In this instance, when the channel index (that is, 3) is transferred from the

Miss controller 332, weights for all channels 0, 3, and 127 including the information may be loaded to the SIMD line 310.

FIG. 6 illustrates an example of a state before the weight for the input channel 3 is stored in the outlier cache 320.

Meanwhile, according to a valid bit area of the outlier cache 320, the weights corresponding to the input channels 0 and 127 are all determined to be valid, and thus previously stored information may be loaded into the SIMD line 310 and used for an MAC operation without requesting a separate weight for the input channels 0 and 127.

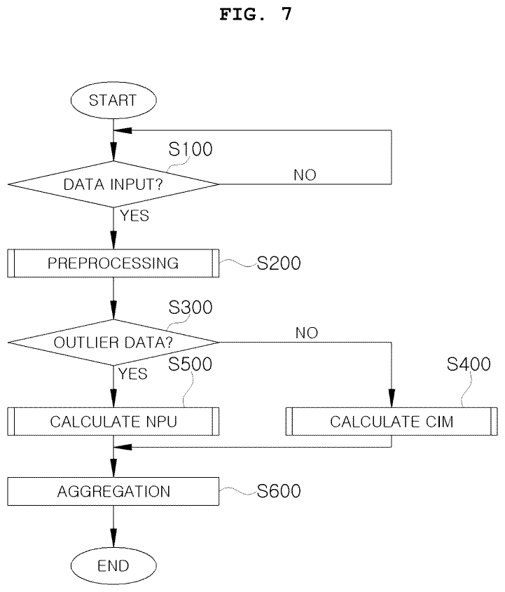

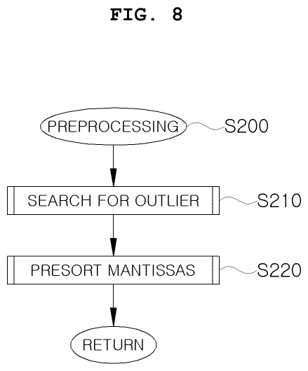

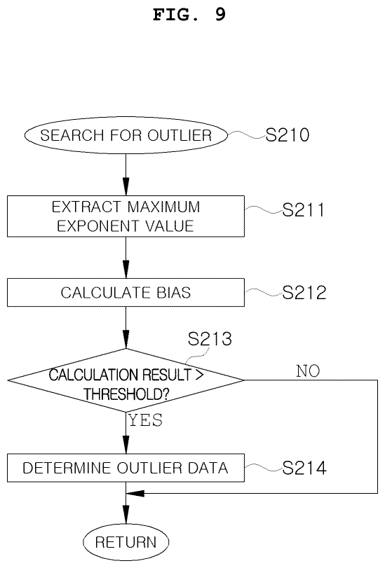

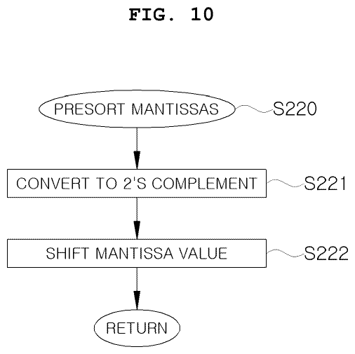

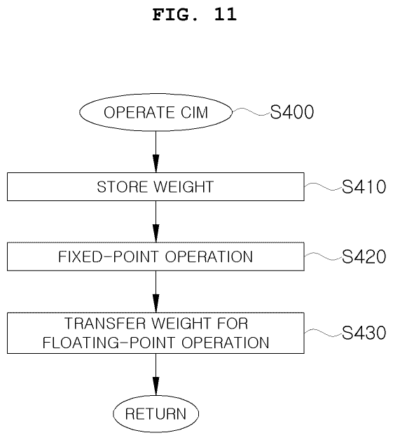

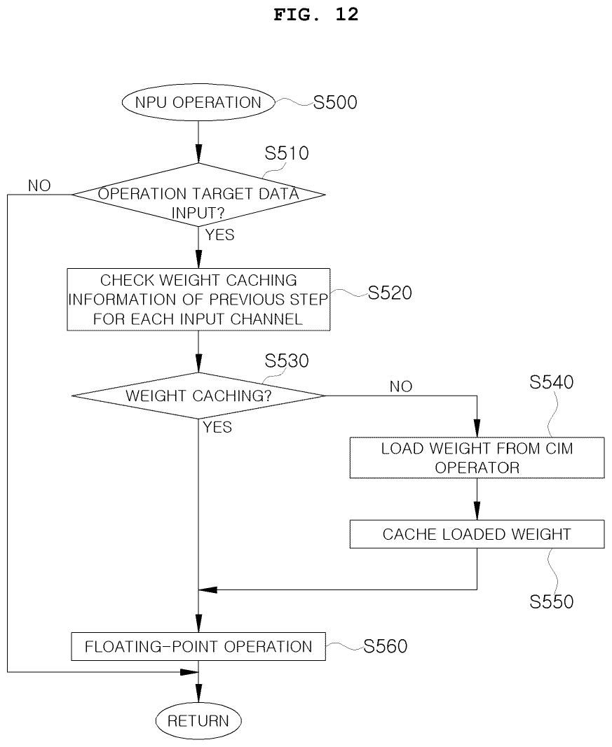

FIGS. 7 to 12 are processing flowcharts of a method for a floating-point operation using the DNN operation apparatus according to an embodiment of the present invention.

Referring to FIGS. 1 to 12, a description will be given of a method for a floating-point operation of the DNN operation apparatus 100 according to an embodiment of the present invention as follows.

First, in steps S100 and S200, the preprocessor 120 classifies outlier data and inlier data from a predetermined number pieces of grouped and input floating-point data, and performs presorting on the inlier data.

To this end, in step S210, the outlier searcher 121 of the preprocessor 120 finds the maximum exponent value Emax among the exponent values of each piece of the floating-point data, and then determines floating-point data whose difference between the exponent value and the maximum exponent value Emax exceeds the preset threshold Th as outlier data. After the maximum exponent value Emax is extracted by a comparison tree in step S211, a difference value between an exponent value of each piece of the floating-point data and the maximum exponent value Emax is calculated in step S212, and each difference value is compared with the preset threshold Th to determine whether the data is outlier data in steps S213 and S214.

Meanwhile, the mantissa preprocessor 122 of the preprocessor 120 performs presorting on a mantissa value based on the difference value between the maximum exponent value Emax and the exponent value for each piece of the inlier data excluding the outlier data among the pieces of floating-point data in step S220, coverts a mantissa value of each piece of the inlier data into a 2's complement form including the corresponding sign in step S221, and then performs a shift operation on the mantissa value based on the difference value in step S222.

In steps S300 to S500, the DNN operation apparatus 100 performs a CIM operation or an NPU operation based on a processing result of step S200.

In step S400, the CIM operator 130 performs a fixed- point operation on the inlier data. To this end, the CIM operator 130 stores a 1-bit weight for the DNN operation in the plurality of CIM cells 200 for processing the CIM operation in step S410, receives input of the inlier data by the compute word line CWL implemented separately from the read word line RWL of the CIM cell 100 and performs a fixed-point operation to perform a multiplication operation on the inlier data and the weight in step S420, and transfers a weight for the floating-point operation in step S430. That is, in step S430, the CIM operator 130 delivers the weight to the NPU operator 140 by the read word line RWL and read bit line pair RBL/RBLB signal applied to the CIM cell 200.

In step S500, the NPU operator 140 receives the outlier data and corresponding input channel information from the preprocessor 120, and performs a floating-point operation on the outlier data. To this end, in step S500, the NPU operator 140 may read a weight for each input channel for the floating-point operation on the outlier data through a separate transmission line implemented in the CIM operator 130, and perform a control operation so that the outlier data is processed in parallel with an operation cycle of the inlier data.

In particular, step S500 includes a floating-point operation step in which the NPU operator 140 performs a floating-point operation on the outlier data using a weight for each input channel read from the CIM operator 130 and a weight caching step in which the NPU operator 140 stores the weight used in the floating-point operation for each input channel in the outlier cache 320. The NPU operator 140 checks weight caching information of a previous step for each input channel of the corresponding data in response to input of data subjected to the floating-point operation in steps S510 and S520, optionally performs a step of reading a weight from the CIM operator 130 and caching the weight depending on whether the weight is cached in steps S530 to S550, and performs a floating-point operation using the cached weight in step S560.

That is, in steps S540 and S550, the NPU operator 140 performs a step of requesting a weight from the CIM operator 130 for an input channel whose weight is not cached among input channels of operation target data, and then caching the weight received in response thereto in the outlier cache 320, and in step S560, the NPU operator 140 performs a floating- point operation by loading the weight cached in the outlier cache 320 into the SIMD line 310.

In step S600, the aggregation core 150 sums and outputs a CIM operation result of step S400 and an NPU operation result of step S500.

In the description of the method of the present invention with reference to FIGS. 1 to 12, duplicate description of content mentioned in the description of the DNN operation apparatus 100 of the present invention with reference to FIGS. 1 to 6 has been omitted.

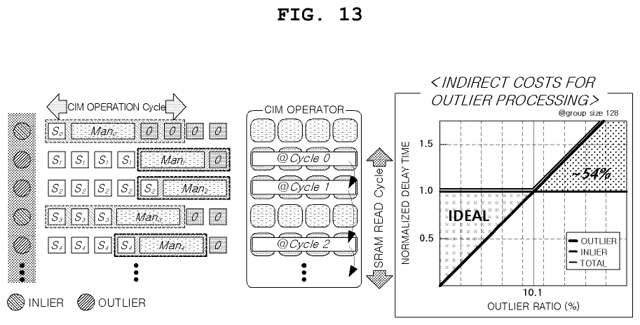

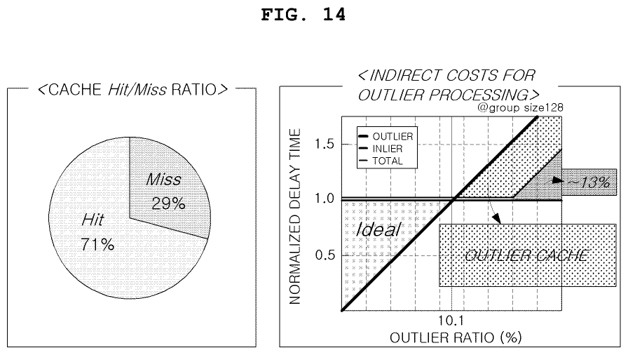

FIGS. 13 and 14 are diagrams illustrating and describing effects of the DNN operation apparatus and the method for the floating-point operation using the same according to an embodiment of the present invention. FIG. 13 illustrates a cause and result of indirect costs for outlier processing in a CIM-NPU heterogeneous architecture via a separated data path, and FIG. 14 illustrates and describes content of a cache hit rate (Hit/Miss ratio) and a reduction in indirect costs for outlier processing when the outlier cache proposed in the present invention is applied to an actual data set.

Referring to FIGS. 1 to 6 and FIG. 13, an operation cycle required by the CIM operator 130 is determined by a bit width of inlier data whose mantissas are presorted, and an operation cycle required by the NPU operator 140 is determined by the number of outliers. The NPU operator 140 fetches a weight from the CIM operator 130 for outlier data processing in outlier data processing, and a characteristic of SRAM reading that allows reading once per cycle at this time is a cause thereof.

A rightmost graph of FIG. 13 is a graph that analyzes a delay time of each operator and a delay time of the entire system according to an outlier ratio for an actual data set (ImageNet) and a model (ResNet50). Referring to the graph, it can be seen that the delay time of the CIM operator 130 (that is, inlier data) remains constant at all outlier ratios, whereas the delay time of the NPU operator 140 (that is, outlier data) increases in proportion to the outlier ratio. It can be seen that the delay time of the entire system is delayed in the NPU operator 140 for outliers of 10.1% or more, and such cases account for approximately 54% of the total.

As a result, it can be seen that there is a limit to improving processing efficiency of outlier data only using a method of separating inlier data and outlier data and processing the data in parallel.

Therefore, to overcome this limit, the present invention introduces an outlier caching technique. This is due to the characteristic that outliers occur in similar channels in different groups, and in this way, it is possible to reduce unnecessary SRAM read operations.

FIGS. 1 to 6 and FIG. 14 show content of a cache hit rate (Hit/Miss ratio) and a reduction in indirect costs of outlier processing when the outlier cache proposed in the present invention is applied to an actual data set (ImageNet) and model (ResNet50).

First, referring to a circular graph illustrated on the left side of FIG. 14, it can be seen that the cache hit rate is approximately 71%, which means that a rate of accessing the actual CIM operator 130 to read duplicate values has decreased.

Meanwhile, a graph illustrated on the right side of FIG. indirect costs for outlier 14 is a graph illustrating processing using an operation processing delay time of a normalized system. When the graph is compared with the graph of FIG. 13, it can be seen that, even though the NPU operator is constrained so that the delay time of the system linearly increases (see the graph of FIG. 13) as an outlier ratio increases due to the SRAM read operation for outlier processing in the CIM-NPU heterogeneous architecture before applying the outlier cache, when unnecessary SRAM read operations are reduced by introducing the outlier cache, the frequency of access to the SRAM when handling outliers is reduced, and the NPU operation may be finished within the delay time of the CIM operator for a specific outlier ratio (see the right graph of FIG. 14).

As a result, it can be seen that, when the present invention is applied to the operation of the DNN, only about 13% of the total workload is limited by the delay time of outlier processing, and the time itself is reduced due to the outlier cache. Accordingly, it was confirmed that the present invention increases processing throughput and energy efficiency of the operation by obtaining an improved processing throughput of about 39% for the above-mentioned actual dataset and model.

As such, an apparatus for operating a DNN and a method for a floating-point operation using the same of the present invention have characteristics of being able to improve operation speed and energy efficiency by classifying a predetermined number of pieces of floating-point data grouped and input for an operation into outlier data and inlier data, separating and processing these pieces of data through a separate operator, and then summing and outputting respective operation results.

In addition, the present invention has characteristics of enabling parallel processing of outlier data and inlier data by including a CIM operator configured to perform a fixed-point operation on the inlier data and an NPU configured to perform a floating-point operation on the outlier data, and providing a weight required for the floating-point operation using a transmission path separate from a data path for the fixed-point operation of the CIM operator.

In addition, the present invention has characteristics of caching a previously used weight for each input channel of outlier data, and then using the cached weight during operation of the outlier data on the same channel, so that a process of loading a weight from a CIM operator may be omitted, thereby reducing a total read cycle to achieve higher throughput and energy efficiency.

As described above, an apparatus for operating a DNN and a method for a floating-point operation using the same of the present invention have effects of being able to improve operation speed and energy efficiency by classifying a predetermined number of pieces of floating-point data grouped and input for an operation into outlier data and inlier data, separating and processing these pieces of data through a separate operator, and then summing and outputting respective operation results.

In addition, the present invention has effects of being able to enable parallel processing of outlier data and inlier data by including a CIM operator configured to perform a fixed-point operation on the inlier data and an NPU configured to perform a floating-point operation on the outlier data, and providing a weight required for the floating-point operation using a transmission path separate from a data path for the fixed-point operation of the CIM operator.

In addition, the present invention has effects of reducing a total read cycle to achieve higher throughput and energy efficiency by caching a previously used weight for each input channel of outlier data, and then using the cached weight during operation of the outlier data on the same channel, so that a process of loading a weight from a CIM operator may be omitted.

Even though the embodiments of the present invention have been described above, the scope of the present invention is not limited thereto, and the present invention includes all changes and modifications easily modified by a person having ordinary skill in the art to which the present invention pertains from the embodiments and recognized as equivalent.

What is claimed is:

1. An apparatus for a deep neural network (DNN) operation for an energy-efficient floating-point operation, the apparatus comprising:
a preprocessor configured to classify outlier data and inlier data from a predetermined number of pieces of grouped and input floating-point data and to perform presorting on the inlier data;
a computing-in-memory (CIM) operator configured to perform a fixed-point operation on the inlier data;
a neural processing unit (NPU) operator configured to receive the outlier data and corresponding input channel information from the preprocessor and to perform a floating-point operation on the outlier data; and
an aggregation core configured to sum and output an operation result of each of the CIM operator and the NPU operator,
wherein the NPU operator reads a weight for each input channel for the floating-point operation on the outlier data through a separate transmission line implemented in the CIM operator, and causes the outlier data to be processed in parallel with an operation cycle of the inlier data.

2. The apparatus according to claim 1, wherein the preprocessor comprises:
an outlier searcher configured to find a maximum exponent value Emax among exponent values of each piece of the floating-point data, and then determine floating-point data, in which a difference between an exponent value and the maximum exponent value Emax exceeds a preset threshold Th, as outlier data; and
a mantissa preprocessor configured to presort mantissa values based on a difference value between the maximum exponent value Emax and the exponent value for each piece of remaining inlier data excluding the outlier data among the pieces of floating-point data.

3. The apparatus according to claim 2, wherein the outlier searcher comprises:
a comparator configured to extract the maximum exponent value Emax by a comparison tree;
a bias operator configured to calculate a difference value between the maximum exponent value Emax and an exponent value of each piece of the floating-point data; and
a comparator configured to compare each difference value with the preset threshold Th to determine whether data is outlier data.

4. The apparatus according to claim 2, wherein the mantissa preprocessor comprises:
a converter configured to convert a mantissa value of each piece of the inlier data to a 2's complement form including a corresponding sign; and
a shift operator configured to perform a shift operation on the mantissa value based on the difference value.

5. The apparatus according to claim 1, wherein:
the CIM operator comprises a plurality of CIM cells storing a 1-bit weight for the DNN operation, and
each of the CIM cell comprises:
an SRAM cell configured to support an operation of reading/writing the weight through a read word line RWL and a read bit line pair RBL/RBLB and to transfer the weight to the NPU operator; and
a NOR operator configured to receive input of the inlier data through a compute work line CWL implemented separately from the read word line RWL and to perform a multiplication operation on the inlier data and the weight.

6. The apparatus according to claim 1, wherein:
the NPU operator comprises at least one single instruction multiple data (SIMD) core matched with the CIM operator to perform the floating-point operation, and
the SIMD core comprises:
a plurality of SIMD lines configured to perform a floating-point operation on pieces of outlier data sequentially input from the preprocessor according to an input channel thereof;
an outlier cache configured to store a weight for each input channel read from the CIM operator in a previous floating-point operation; and
a cache controller configured to read a weight for each input channel of each piece of outlier data of a currently input floating-point data group from the outlier cache and to load the read weight into the SIMD line.

7. The apparatus according to claim 6, wherein the cache controller further performs a process of requesting a weight from the CIM operator for an input channel whose corresponding weight is not stored in the outlier data among input channels of the outlier data and storing a received weight in the outlier cache in response thereto.

8. A method for a floating-point operation using an apparatus for a DNN operation comprising a preprocessor configured to perform preprocessing on a predetermined number of pieces of grouped and input floating-point data for a floating-point operation, a CIM operator configured to perform a fixed-point operation on inlier data, an NPU operator configured to perform a floating-point operation on outlier data, and an aggregation core configured to sum and output an operation result of each of the CIM operator and the NPU operator, the method comprising:
a preprocessing step of classifying, by the preprocessor, outlier data and inlier data from a predetermined number of pieces of grouped and input floating-point data and performing presorting on the inlier data;
a CIM operation step of performing, by the CIM operator, a fixed-point operation on the inlier data;
an NPU operation step of receiving, by the NPU operator, the outlier data and corresponding input channel information from the preprocessor and performing a floating-point operation on the outlier data; and
an aggregation step of summing and outputting, by the aggregation core, an operation result of each of the CIM operation step and the NPU operation step,
wherein the NPU operation step comprises reading a weight for each input channel for the floating-point operation on the outlier data through a separate transmission line implemented in the CIM operator, and causing the outlier data to be processed in parallel with an operation cycle of the inlier data.

9. The method according to claim 8, wherein the preprocessing step comprises:
an outlier search step of finding a maximum exponent value Emax among exponent values of each piece of the floating-point data, and then determining floating-point data, in which a difference between an exponent value and the maximum exponent value Emax exceeds a preset threshold Th, as outlier data; and
a mantissa presorting step of presorting mantissa values based on a difference value between the maximum exponent value Emax and the exponent value for each piece of remaining inlier data excluding the outlier data among the pieces of floating-point data.

10. The method according to claim 9, wherein the outlier search step comprises:
a maximum exponent value Emax extraction step of extracting the maximum exponent value Emax by a comparison tree;
a bias operation step of calculating a difference value between the maximum exponent value Emax and an exponent value of each piece of the floating-point data; and
a comparison step of comparing each difference value with the preset threshold Th to determine whether data is outlier data.

11. The method according to claim 10, wherein the mantissa presorting step comprises:
a conversion step of converting a mantissa value of each piece of the inlier data to a 2's complement form including a corresponding sign; and
a shift operation step of performing a shift operation on the mantissa value based on the difference value.

12. The method according to claim 8, wherein the CIM operation step comprises:
a weight storage step of storing a 1-bit weight for the DNN operation in a plurality of CIM cells for processing a CIM operation;
a fixed-point operation step of receiving input of the inlier data by a signal of a compute work line CWL implemented separately from a read word line RWL of each of the CIM cell and performing a multiplication operation on the inlier data and the weight; and
a weight transfer step of transferring the weight to the NPU operator by a read word line RWL and read bit line pair RBL/RBLB signal applied to the CIM cell.

13. The method according to claim 8, wherein:
the NPU operation step comprises:
a floating-point operation step of performing a floating-point operation on the outlier data using a weight for each input channel read from the CIM operator; and
a weight caching step of storing the weight used for the floating-point operation for each input channel in an outlier cache, and
the floating-point operation step comprises a weight loading step of loading a weight for each input channel prestored in the outlier cache for an operation of each piece of the outlier data.

14. The method according to claim 13, wherein the NPU operation step comprises:
a weight request step of requesting a weight from the CIM operator for an input channel whose corresponding weight is not stored in the outlier data among input channels of the outlier data; and
a weight storage step of storing a weight received from the CIM operator in the outlier cache.
